(19) United States
(12) Patent Application Publication
(10) Pub. No.: US 2016/0283357 A1
(43) Pub. Date: Sep. 29, 2016

(54) CALL STACK RELATIONSHIP ACQUIRING METHOD AND APPARATUS

(71) Applicant: TENCENT TECHNOLOGY (SHENZHEN) COMPANY LIMITED, Shenzhen (CN)

(72) Inventor: Tianshi Mu, Shenzhen (CN)

(21) Appl. No.: 15/173,118

(22) Filed: Jun. 3, 2016

Related U.S. Application Data
(63) Continuation of application No. PCT/CN2015/073562, filed on Mar. 3, 2015.

(30) Foreign Application Priority Data
Mar. 7, 2014 (CN) 201410084414.7

(51) Int. Cl. G06F 11/36

(52) U.S. Cl. CPC G06F 11/3668

(57) ABSTRACT

The present disclosure relates to the field of network technologies and discloses a call stack relationship acquiring method and apparatus. The method includes: recording, for each page that is opened, multiple code files loaded on the page; acquiring, for each function in the multiple code files that is run on the page, at least a calling hierarchy of the function when the function starts to run and finishes running, the calling hierarchy of the function including at least one of a function name calling the function and a function name called by the function; and obtaining a call stack relationship of the multiple code files according to the calling hierarchy of each function in the multiple code files.

### CROSS REFERENCE TO RELATED APPLICATIONS

This is a continuation application of International Patent Application No. PCT/CN2015/073562, filed on Mar. 3, 2015, which claims priority to Chinese Patent Application No. 201410084414.7 filed on Mar. 7, 2014, the disclosures of which are incorporated by reference herein in their entirety.

### FIELD OF THE TECHNOLOGY

The present disclosure relates to the field of network technologies, and more particularly to a call stack relationship acquiring method and apparatus.

### BACKGROUND OF THE DISCLOSURE

A call stack relationship of JavaScript functions refers to a calling relationship between JavaScript functions. For example, function a of file A calls function b of file B, function b of file B calls function c of file C, and accordingly, the call stack relationship may be expressed as: A:a→B:b→C:c. A developer can read JavaScript code according to the call stack relationship of JavaScript functions when there is a lack of corresponding function names and program comments.

Generally, before release of JavaScript code, a JavaScript code obfuscation technique is used to obfuscate JavaScript code to be released, to change all variables, functions and class names in the code to be released into short English letter designations and remove redundant information in the code to be released, so that the code after obfuscation has the same functionalities as the code before obfuscation, and the code after obfuscation is difficult to decompile, thereby protecting the JavaScript code.

As the code after obfuscation lacks corresponding function names and program comments, the developer cannot read the code after obfuscation, cannot acquire the calling relationship between functions in the code after obfuscation, and thus cannot test the code after obfuscation.

### SUMMARY

A call stack relationship acquiring method and apparatus are provided as follows:

In one aspect, a call stack relationship acquiring method is provided, where the method includes:

recording, for each page that is opened, multiple code files loaded on the page;

acquiring, for each function in the multiple code files that is run on the page, at least a calling hierarchy of the function when the function starts to run and finishes running, the calling hierarchy of the function including at least one of a function name calling the function and a function name called by the function; and

obtaining a call stack relationship of the multiple code files according to the calling hierarchy of each function in the multiple code files.

In another aspect, a call stack relationship acquiring apparatus is provided, where the apparatus includes:

a code file loading module, configured to record, for each page that is opened, multiple code files loaded on the page;

a call information acquiring module, configured to acquire, for each function in the multiple code files that is run on the page, at least a calling hierarchy of the function when the function starts to run and finishes running, the calling hierarchy of the function including at least one of a function name calling the function and a function name called by the function; and

a call stack relationship acquiring module, configured to obtain a call stack relationship of the multiple code files according to the calling hierarchy of each function in the multiple code files.

### BRIEF DESCRIPTION OF THE DRAWINGS

To describe the technical solutions of the embodiments of the present invention more clearly, the following briefly introduces the accompanying drawings required for describing the embodiments. Apparently, the accompanying drawings in the following description show only some embodiments of the present invention, and a person of ordinary skill in the art may still derive other drawings from these accompanying drawings without creative efforts.

FIG. 1 is a flowchart of a call stack relationship acquiring method according to an embodiment of the present invention;

FIG. 2 is a flowchart of a call stack relationship acquiring method according to an embodiment of the present invention;

FIG. 3 is a schematic diagram of acquiring a 2-tuple according to an embodiment of the present invention;

FIG. 4 is a schematic diagram of acquiring a call stack relationship according to an embodiment of the present invention;

FIG. 5 is a schematic diagram of an application of a call stack relationship according to an embodiment of the present invention;

FIG. 6 is a schematic diagram of an application of a call stack relationship according to an embodiment of the present invention; and

FIG. 7 is a schematic structural diagram of a call stack relationship acquiring apparatus according to an embodiment of the present invention.

### DESCRIPTION OF EMBODIMENTS

To make the objectives, technical solutions and advantages of the present disclosure clearer, implementation manners of the present disclosure are further described in detail with reference to the accompanying drawings.

The call stack relationship acquiring method provided in the embodiments of the present invention can be executed by a computing device, the computing device having one or more processors and memory storing program modules for implementing the call stack relationship acquiring method. Modules included in the call stack relationship acquiring apparatus provided in the embodiments of the present invention are program modules that correspond to the steps of the call stack relationship acquiring method, and consist of multiple instructions or multiple sets of instructions. The call stack relationship acquiring apparatus provided in the embodiments of the present invention can be stored in the memory of the computing device.

Computing device is a device capable of executing a software system/method. The computing device may, for example, be a device such as a personal desktop computer or a portable device, such as a laptop computer, a tablet computer, a cellular telephone, or a smart phone. The computer may also be a server that connects to the above devices locally or via a network.

Memory includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory may optionally include one or more storage devices remotely located from the CPU(s). Memory, or alternately the non-volatile memory device(s) within memory, comprises a non-transitory computer readable storage medium.

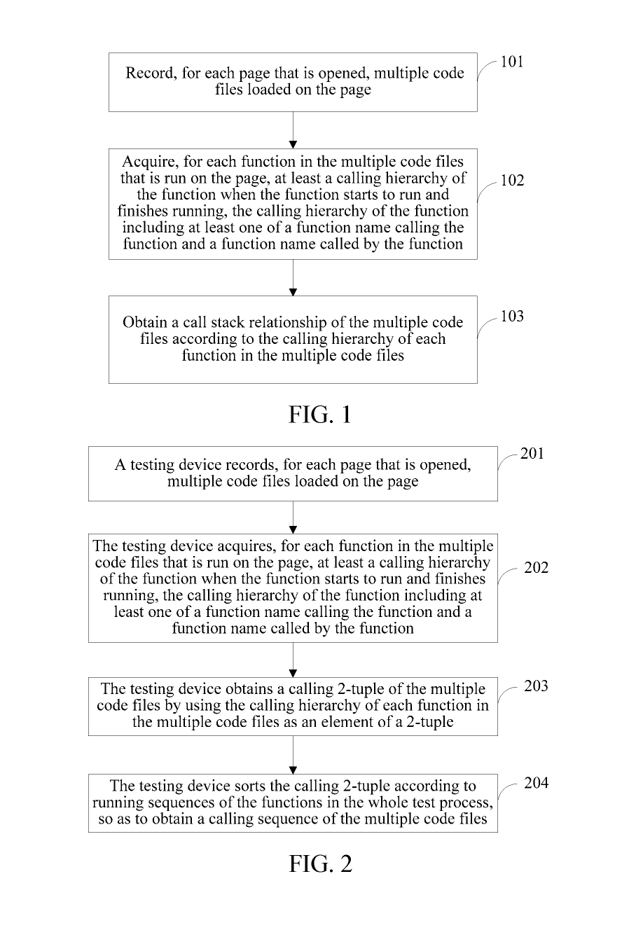

FIG. 1 is a flowchart of a call stack relationship acquiring method according to an embodiment of the present invention. Referring to FIG. 1, this embodiment includes:

101: Record, for each page that is opened, multiple code files loaded on the page.

102: Acquire, for each function in the multiple code files that is run on the page, at least a calling hierarchy of the function when the function starts to run and finishes running, the calling hierarchy of the function including at least one of a function name calling the function and a function name called by the function.

103: Obtain a call stack relationship of the multiple code files according to the calling hierarchy of each function in the multiple code files.

In the method according to this embodiment of the present invention, during code execution, for each page that is opened, multiple code files loaded on the page are recorded, and a calling hierarchy of each function in the multiple code files on the page when the function starts to run and finishes running is recorded, so as to obtain a call stack relationship of the multiple code files on the page. The call stack relationship can intuitively display the logical calling relationship between the functions of the multiple code files on the page, so that a developer can test the code even if there is a lack of corresponding function names and program comments.

Optionally, the acquiring, for each function in the multiple code files that is run on the page, at least a calling hierarchy of the function when the function starts to run and finishes running includes:

acquiring, for each function in the multiple code files that is run on the page, at least the function name calling the function, when the function starts to run; and

acquiring the function name called by the function, at least when the function finishes running.

Optionally, the method further includes:

acquiring, for each function in the multiple code files that is run on the page, line numbers of the function when the function starts to run and finishes running.

Optionally, the method further includes:

determining a function that corresponds to a changed line number;

determining, according to the call stack relationship of the multiple code files, a part to which the function corresponds in the output call stack relationship; and

determining, according to the part to which the function corresponds in the output call stack relationship, functionalities affected by the current change in line number.

Optionally, the determining, according to the part to which the function corresponds in the output call stack relationship, functionalities affected by the current change in line number includes:

determining, according to the part to which the function corresponds in the output call stack relationship, the code file that corresponds to the corresponding part in the call stack relationship; and

determining, according to the code file, corresponding functionalities of the page on which the code file is loaded.

Optionally, the method further includes:

obfuscating the multiple code files to obtain release code;

determining, according to the call stack relationship of the multiple code files, a calling relationship between functions in the release code; and

adjusting the release code according to the calling relationship between functions in the release code.

FIG. 2 is a flowchart of a call stack relationship acquiring method according to an embodiment of the present invention. This embodiment of the present invention is described through an example in which multiple javascript files are loaded on a page. Referring to FIG. 2, this embodiment includes:

201: A testing device records, for each page that is opened, multiple code files loaded on the page.

Multiple code files may be loaded on one page, each of the code files includes multiple functions, and each of the code files corresponds to some functionalities of the page. When each page is opened, the testing device loads multiple code files, and when receiving an instruction of executing a functionality on the page, the testing device may run the functions in the code file corresponding to the functionality, so as to achieve the functionality.

In this embodiment of the present invention, when code is tested, updated or otherwise processed, for each page that is opened, multiple code files loaded on the page are recorded. The code may be code compiled using the JavaScript language or the C language, which is not specifically limited in this embodiment of the present invention.

In this embodiment of the present invention, the manner in which the testing device records the multiple code files loaded on the page may be assigning a global variable to the code, where the global variable may be named window.jsarray, and the global variable window.jsarray is used to record all code files loaded on the current page.

By taking the following javascript code for example, specific code is as follows:

```
            (function( ){
              if (window.jsarray === undefined){
              window.jsarray = [ ]; //to record all js lists loaded
              on the current page
              }
window.jsarray.push(“/home/XXspace/XXMail/js_obfuscator/
current_name.js”);
            })( );
```

In the javascript code, content following “//” until the end of the line is comments in the javascript code, and “/home/XXspace/XXMail/js_obfuscator/current_name.js” is an address of the loaded code file.

202: The testing device acquires, for each function in the multiple code files that is run on the page, at least a calling hierarchy of the function when the function starts to run and finishes running, the calling hierarchy of the function including at least one of a function name calling the function and a function name called by the function.

There is a calling relationship between the functions in the multiple code files that are run on the page. By taking function A and function B for example, the calling relationship between the functions may be that function A calls function B when function A finishes running, or may be that function A calls function B during running.

In this embodiment of the present invention, for each function in the multiple code files that is run on the page, at least the function name calling the function is acquired when the function starts to run, and at least the function name called by the function is acquired when the function finishes running.

For example, by taking function a of file A, function b of file B, and function c of file C for example, assuming that function a of file A calls function b of file B, function a is the first level of the call and function b is the second level of the call; if function b of file B calls function c of file C, function c is the third level of the call. When the testing device proceeds to function b of file B, the testing device acquires, when function b of file B starts to run, the function name of function a of file A that calls function b of file B; and acquires, when function b of file B finishes running, the function name of function c of file C that is called by function b of file B.

Further optionally, for each function in the multiple code files that is run on the page, when the function starts to run and finishes running, the testing device may further acquire run time of the function in addition to acquiring the calling hierarchy of the function, that is, acquire, when the function starts to run, the time at which the function starts to run, and acquire, when the function finishes running, the time at which the function finishes running, so that subsequently if there is a large amount of data during code testing, test processes in different time periods can be distinguished according to the run time of the functions.

Further optionally, for each function in the multiple code files that is run on the page, when the function starts to run and finishes running, the testing device may further acquire line numbers of the function in addition to acquiring the calling hierarchy of the function, that is, acquire, when the function starts to run, a line number from which the function starts to run, and acquire, when the function finishes running, a line number at which the function finishes running, so that subsequently the range of the function in the code file can be conveniently located according to the line numbers.

In this embodiment of the present invention, the manner in which the testing device acquires the calling hierarchy of the function may be assigning another global variable to the code, where the global variable is named window.jslevel, and the global variable window.jslevel is used to record the calling hierarchy of the function.

By taking the following javascript code for example, specific code is as follows:

```
          function_createProxy( )
          {
            /** debug-on **/
            window.jslevel++;
            console.log(“i=e”+window.jslevel+“&s=_createProxy(start
line number, end line number)”);
            /** debug-off **/
          {... }
            /** debug-on **/
            console.log(“i=l”+window.jslevel+“&s=_createProxy(start
line number, end line number)”);
            window.jslevel−−;
            /** debug-off **/
```

“/** debug-on **/” indicates the start of code testing, and /** debug-off **/indicates the end of code testing; the function console.log( ) is used to output the calling hierarchy and line numbers of the function.

203: The testing device obtains a calling 2-tuple of the multiple code files by using the calling hierarchy of each function in the multiple code files as an element of a 2-tuple.

In this embodiment of the present invention, when each function starts to run and finishes running, the testing device collects the calling hierarchy, run time, line numbers and the like of each function, and obtains a calling 2-tuple of the multiple code files according to the calling hierarchies, where the calling 2-tuple uses the calling hierarchy of each function as an element, and the 2-tuple may be in a format of (file A::function A→file B::function B). For example, assuming that the function calling hierarchy collected by the testing device are that function A of file A calls function B of file B and function B of file B calls function C of file C, the calling 2-tuple may be (file A::function A→file B::function B), and (file B::function B→file C::function C).

It should be noted that in this embodiment of the present invention, information such as the calling hierarchy, run time and line numbers of each function is stored locally in the testing device, and the testing device obtains a calling 2-tuple of the multiple code files according to the stored calling hierarchies. In fact, in another embodiment of the present invention, the testing device may also report the information such as the calling hierarchy, run time and line numbers of each function to a server, so that the server obtains a calling 2-tuple of the multiple code files according to the reported calling hierarchy. That is, the testing device may report, through a common gateway interface (CGI) when each function starts to run and finishes running, the calling hierarchy, run time, line numbers and the like of each function to a server, so that the server obtains a calling 2-tuple of the multiple code files according to the reported calling hierarchies, where the calling 2-tuple uses the calling hierarchy of each function as an element.

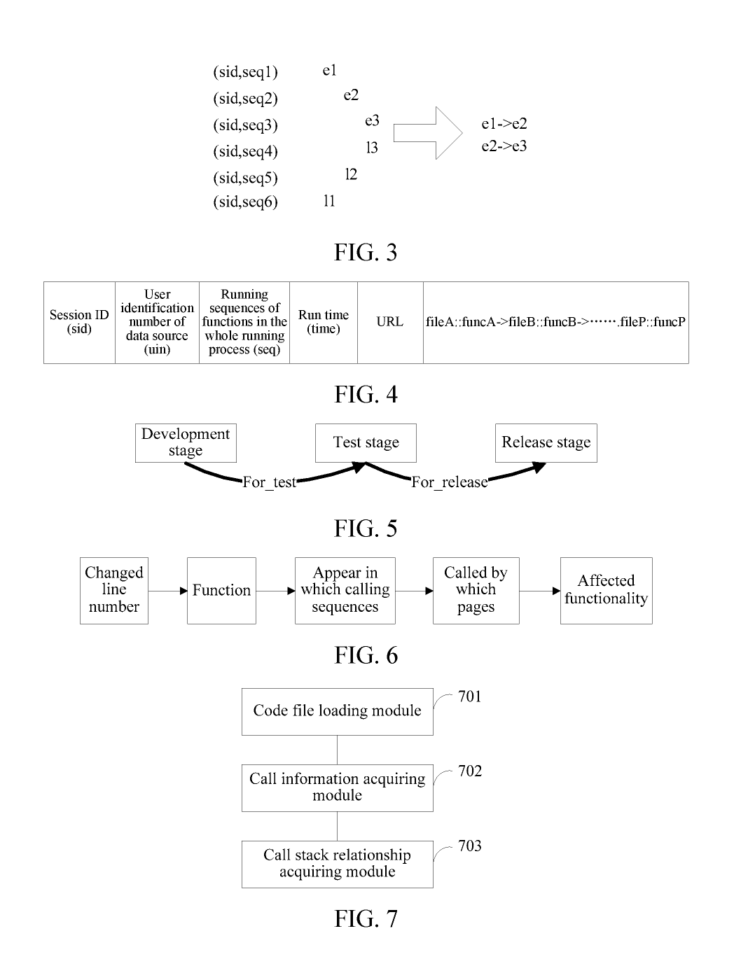

FIG. 3 is a schematic diagram showing that the testing device obtains a 2-tuple according to a reported log. In FIG. 3, raw logs are shown on the left, and the testing device groups the raw logs according to session identities (sid); sorts functions according to running sequences (seq) of the functions in the whole running process, to obtain an intermediate calling hierarchy structure, that is, e1, e2 and e3 indicate a sequence in which the functions start to run, and l3, l2 and l1 indicate a sequence in which the functions finish running; and obtains a 2-tuple according to the calling relationship between the functions. The session ID is used to uniquely identify one test process, and each time a browser is opened, one session is set up.

Uniform Resource Locator (URL) is a brief representation of the location and access method of a resource available from the Internet, and is the standard address of an Internet resource; CGI is physically a program that runs on a server to provide an interface to the page of a client. Each page corresponds to one URL, and during running of each function in multiple code files loaded to the URL, the testing device reports, through the CGI, the calling hierarchy, run time, line numbers and the like of each function to a server, so that the server can determine, according to the recorded multiple code files loaded on each page, a mapping relationship between the multiple code files and the CGI.

204: The testing device sorts the calling 2-tuple according to running sequences of the functions in the whole test process, so as to obtain a calling sequence of the multiple code files.

In an implementation of the present disclosure, the testing device runs the functions in the multiple code files in time order, and accordingly, the testing device sorts the calling 2-tuple according to the running sequences of the functions in the whole test process, thus obtaining a calling sequence of the multiple code files. For example, assuming that the 2-tuple is (file A::function A→file B::function B), (file B::function B→file C::function C), and (file C::function C→file D::function D), file A::function A is the first one that runs in the whole test process, file B::function B is the second one that runs in the whole test process, and file C::function C is the third one that runs in the whole test process, and therefore the calling sequence of the multiple code files is file A::function A→file B::function B→file C::function C→file D::function D.

When running each function in multiple code files on a page, the testing device collects information such as session IDs of each function when starting to run and finishing running, a user identification number of a data source, the running sequences of the functions in the whole running process, the run time and the like, and the testing device obtains a calling sequence of the page according to the collected information such as session IDs during running of all the functions in the multiple code files of the page, the user identification number of the data source, the running sequences of the functions in the whole running process, and the run time. Therefore, the information such as the session ID during running of all the functions in the multiple code files of the page, the user identification number of the data source, the running sequences of the functions in the whole running process, and the run time, as well as the URL of the page and the calling sequence of the page may be correspondingly stored in a call stack in the form as shown in FIG. 4.

It should be noted that step 203 and step 204 are a process of obtaining a call stack relationship of the multiple code files according to the calling hierarchy of each function in the multiple code files. In this embodiment of the present invention, the call stack relationship of the multiple code files is expressed in the form of a calling sequence, and in another embodiment of the present invention, the call stack relationship of the multiple code files may also be expressed in the form of a chart, which is not specifically limited in this embodiment of the present invention.

In the method according to this embodiment of the present invention, during code execution, for each page that is opened, multiple code files loaded on the page are recorded, and a calling hierarchy of each function in the multiple code files on the page when the function starts to run and finishes running is recorded, so as to obtain a call stack relationship of the multiple code files on the page. The call stack relationship can intuitively display the logical calling relationship between the functions of the multiple code files on the page, so that a developer can test the code even if there is a lack of corresponding function names and program comments.

Control over the code can be achieved by using the call stack relationship acquiring method according to this embodiment of the present invention, and the code may include the following three types:

a. development code (development source code)

The development code is non-obfuscated, and contains debugging information, comment information, spaces, line feeds, and so on.

b. tested code (for development and test)

The tested code may be obfuscated, and does not contain debugging information or comment information. Alternatively, the tested code may be non-obfuscated, and contains debugging information, comment information, spaces, line feeds and the like.

c. release code (released to users)

The release code is obfuscated, does not contain debugging information or comment information, and may contain or not contain spaces and line feeds.

In addition, as shown in FIG. 5, by using the call stack relationship acquiring method according to this embodiment of the present invention, the following two operations can be implemented:

for_test operation: performing static syntax analysis of the code, inserting the code at the function entry and exit, obtaining the call stack relationship of functions by parsing, obfuscating the code so that the test can be carried out based on the tested code, and collecting the calling sequence; and

for_release operation: deleting debugging information from the code to ensure that the code is obfuscated, and deleting comments, spaces, line feeds and the like to compress the code, so as to ensure security of the code released.

According to the above two operations, from the code development stage through the test stage to the release stage, the developer can fully control the code, and may choose to:

1. directly perform the for_release operation on the development code;

2. perform the for_test operation on the development code first, not perform obfuscation, and after the code passes the test, perform the for_release operation; or

3. perform the for_test operation on the development code first, perform obfuscation, test the obfuscated code, and then perform the for_release operation.

To further describe the effects of this embodiment of the present invention, a specific example is described in detail as follows:

Before code release, when the code is updated, there are differences in line number between the updated code and the released version of code, and therefore a changed line number can be determined by comparing the updated code and the released version of code. If the line number changes, the corresponding function in the code also changes accordingly, and the functionality of the page on which the code file containing the function is loaded also changes. The functionality affected by the current change in line number can be accurately determined by using the call stack relationship of the multiple code files that is obtained in this embodiment of the present invention.

As shown in FIG. 6, the processing process of the testing device includes: determining a function that corresponds to a changed line number; determining, according to the call stack relationship of the multiple code files, a part to which the function corresponds in the output call stack relationship; and determining, according to the part to which the function corresponds in the output call stack relationship, functionalities affected by the current change in line number. Specifically, when the testing device tests, updates or otherwise processes the code, the testing device determines, according to the line numbers collected when the function starts to run and finishes running, a function that corresponds to a changed line number; the function that corresponds to the changed line number may be called by multiple code files, and the testing device determines, according to call stack relationships of the multiple code files, call stack relationships in which the function that corresponds to the changed line number appears, then determines corresponding code files in the call stack relationships, and can determine, according to the recorded code files loaded on each page, the page on which the code file is loaded, thus locating the corresponding functionality of the page on which the code file is loaded.

FIG. 7 is a schematic structural diagram of a call stack relationship acquiring apparatus according to an embodiment of the present invention. Referring to FIG. 7, the apparatus includes: a code file loading module 701, a call information acquiring module 702, and a call stack relationship acquiring module 703.

The code file loading module 701 is configured to record, for each page that is opened, multiple code files loaded on the page; the code file loading module 701 is connected to the call information acquiring module 702, and the call information acquiring module 702 is configured to acquire, for each function in the multiple code files that is run on the page, at least a calling hierarchy of the function when the function starts to run and finishes running, the calling hierarchy of the function including at least one of a function name calling the function and a function name called by the function; and the call information acquiring module 702 is connected to the call stack relationship acquiring module 703, and the call stack relationship acquiring module 703 is configured to obtain a call stack relationship of the multiple code files according to the calling hierarchy of each function in the multiple code files.

Optionally, the call information acquiring module 702 is configured to acquire, for each function in the multiple code files that is run on the page, at least the function name calling the function, when the function starts to run; and acquire at least the function name called by the function, when the function finishes running.

Optionally, the apparatus further includes: a function line number acquiring module, configured to acquire, for each function in the multiple code files that is run on the page, line numbers of the function when the function starts to run and finishes running.

Optionally, the apparatus further includes: a function determining module, configured to determine a function that corresponds to a changed line number; a module for determining a corresponding part in the call stack relationship, configured to determine, according to the call stack relationship of the multiple code files, a part to which the function corresponds in the output call stack relationship; and an affected-functionality determining module, configured to determine, according to the part to which the function corresponds in the output call stack relationship, functionalities affected by the current change in line number. Optionally, the affected-functionality determining module is further configured to determine, according to the part to which the function corresponds in the output call stack relationship, the code file that corresponds to the corresponding part in the call stack relationship; and determine, according to the code file, corresponding functionalities of the page on which the code file is loaded.

Optionally, the apparatus further includes: a release code acquiring module, configured to obfuscate the multiple code files to obtain release code; a function calling relationship determining module, configured to determine, according to the call stack relationship of the multiple code files, a calling relationship between functions in the release code; and a release code adjusting module, configured to adjust the release code according to the calling relationship between functions in the release code.

During code execution, the apparatus according to this embodiment of the present invention records, for each page that is opened, multiple code files loaded on the page, and records a calling hierarchy of each function in the multiple code files on the page when the function starts to run and finishes running, so as to obtain a call stack relationship of the multiple code files on the page. The call stack relationship can intuitively display the logical calling relationship between the functions of the multiple code files on the page, so that a developer can test the code even if there is a lack of corresponding function names and program comments.

It should be noted that the above functional modules are only described for exemplary purposes when the call stack relationship acquiring apparatus provided by the foregoing embodiments acquires a call stack relationship. In actual applications, the functions may be allocated to different functional modules according to specific needs, which means that the internal structure of the apparatus is divided to different functional modules to complete all or some of the above described functions. In addition, the call stack relationship acquiring apparatus provided by the foregoing embodiment is based on the same concept as the call stack relationship acquiring method in the foregoing embodiments. For the specific implementation process, refer to the method embodiments, and the details are not described herein again.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

What is claimed is:

1. A call stack relationship acquiring method implemented by a computing device having one or more processors and a memory storing program for implementing the following steps, wherein the steps comprise:
recording, for each page that is opened, multiple code files loaded on the page;
acquiring, for each function in the multiple code files that is run on the page, at least a calling hierarchy of the function when the function starts to run and finishes running, the calling hierarchy of the function comprising at least one of a function name calling the function and a function name called by the function; and
obtaining a call stack relationship of the multiple code files according to the calling hierarchy of each function in the multiple code files.

2. The method according to claim 1, wherein the acquiring, for each function in the multiple code files that is run on the page, at least a calling hierarchy of the function when the function starts to run and finishes running comprises:
acquiring, for each function in the multiple code files that is run on the page, at least the function name calling the function, when the function starts to run; and
acquiring at least the function name called by the function, when the function finishes running.

3. The method according to claim 1, wherein the steps further comprise:
acquiring, for each function in the multiple code files that is run on the page, line numbers of the function when the function starts to run and finishes running.

4. The method according to claim 3, wherein the steps further comprise:
determining a function that corresponds to a changed line number;
determining, according to the call stack relationship of the multiple code files, a part to which the function corresponds in the output call stack relationship; and
determining, according to the part to which the function corresponds in the output call stack relationship, functionalities affected by the current change in line number.

5. The method according to claim 4, wherein the determining, according to the part to which the function corresponds in the output call stack relationship, functionalities affected by the current change in line number comprises:
determining, according to the part to which the function corresponds in the output call stack relationship, the code file that corresponds to the corresponding part in the call stack relationship; and
determining, according to the code file, corresponding functionalities of the page on which the code file is loaded.

6. The method according to claim 1, wherein the steps further comprise:
obfuscating the multiple code files to obtain release code;
determining, according to the call stack relationship of the multiple code files, a calling relationship between functions in the release code; and
adjusting the release code according to the calling relationship between functions in the release code.

7. The method according to claim 1, wherein the steps further comprise:
acquiring, for each function in the multiple code files that is run on the page, run time of the function when the function starts to run and finishes running.

8. The method according to claim 1, wherein the steps further comprise:
storing the calling hierarchy locally or in a remote server.

9. The method according to claim 1, wherein recording multiple code files loaded on the page is implemented by assigning a global variable to the code files.

10. The method according to claim 1, wherein the call stack relationship of the multiple code files is expressed in the form of a calling sequence or a chart.

11. A call stack relationship acquiring apparatus, comprising one or more processors and a memory storing program modules, wherein the program modules comprise:
a code file loading module, configured to record, for each page that is opened, multiple code files loaded on the page;
a call information acquiring module, configured to acquire, for each function in the multiple code files that is run on the page, at least a calling hierarchy of the function when the function starts to run and finishes running, the calling hierarchy of the function comprising at least one of a function name calling the function and a function name called by the function; and
a call stack relationship acquiring module, configured to obtain a call stack relationship of the multiple code files according to the calling hierarchy of each function in the multiple code files.

12. The apparatus according to claim 11, wherein the call information acquiring module is configured to acquire, for each function in the multiple code files that is run on the page, at least the function name calling the function, when the function starts to run; and acquire at least the function name called by the function, when the function finishes running.

13. The apparatus according to claim 11, wherein the program modules further comprise:
a function line number acquiring module, configured to acquire, for each function in the multiple code files that is run on the page, line numbers of the function when the function starts to run and finishes running.

14. The apparatus according to claim 13, wherein the program modules further comprise:
a function determining module, configured to determine a function that corresponds to a changed line number;
a module for determining a corresponding part in the call stack relationship, configured to determine, according to the call stack relationship of the multiple code files, a part to which the function corresponds in the output call stack relationship; and
an affected-functionality determining module, configured to determine, according to the part to which the function corresponds in the output call stack relationship, functionalities affected by the current change in line number.

15. The apparatus according to claim 14, wherein the affected-functionality determining module is further configured to determine, according to the part to which the function corresponds in the output call stack relationship, the code file that corresponds to the corresponding part in the call stack relationship; and determine, according to the code file, corresponding functionalities of the page on which the code file is loaded.

16. The apparatus according to claim 11, wherein the program modules further comprise:
a release code acquiring module, configured to obfuscate the multiple code files to obtain release code;
a function calling relationship determining module, configured to determine, according to the call stack relationship of the multiple code files, a calling relationship between functions in the release code; and
a release code adjusting module, configured to adjust the release code according to the calling relationship between functions in the release code.

17. The apparatus according to claim 11, wherein the program modules further comprise:
a function run time acquiring module, configured to acquire, for each function in the multiple code files that is run on the page, run time of the function when the function starts to run and finishes running.

18. The apparatus according to claim 11, wherein the program modules further comprise:
a storage module, configured to store the calling hierarchy locally or in a remote server.

19. The apparatus according to claim 11, wherein the code file loading module records multiple code files loaded on the page by assigning a global variable to the code files.

20. The apparatus according to claim 11, wherein the call stack relationship of the multiple code files is expressed in the form of a calling sequence or a chart.
